(19) United States
(12) Patent Application Publication
(10) Pub. No.: US 2020/0266014 A1
(43) Pub. Date: Aug. 20, 2020

(54) SMALL CIRCUIT BREAKER

(71) Applicant: LSIS CO., LTD., Anyang-si (KR)

(72) Inventors: Kwangwon LEE, Anyang-si (KR); Seungjin HAM, Anyang-si (KR)

(21) Appl. No.: 16/574,820

(22) Filed: Sep. 18, 2019

(30) Foreign Application Priority Data
Feb. 14, 2019 (KR) 10-2019-0017324

(51) Int. Cl. H01H 33/18; H01H 33/60

(52) U.S. Cl. CPC H01H 33/18; H01H 33/60

(57) ABSTRACT

Disclosed is a small circuit breaker. The small circuit breaker according to an embodiment of the present invention is provided with an arc guiding portion at a movable contact carrier. Accordingly, an arc generated as a fixed contact and a movable contact are separated from each other can be smoothly discharged to the outside, along the arc guiding portion. Thus, even in a case that an additional arc chamber is not provided, a generated arc can be discharged smoothly. As a result, damage of the fixed contact and the movable contact, which occurs when an arc is positioned near the fixed contact or the movable contact for an excessively-long time, can be prevented.

### CROSS-REFERENCE TO RELATED APPLICATION

Pursuant to 35 U.S.C. § 119(a), this application claims the benefit of earlier filing date and right of priority to Korean Application No. 10-2019-0017324, filed on Feb. 14, 2019, the contents of which is incorporated by reference herein in its entirety.

### BACKGROUND OF THE INVENTION

### 1. Field of the Invention

The present disclosure relates to a small circuit breaker, and particularly, to a small circuit breaker having a structure capable of effectively discharging an arc to the outside without an arc chamber.

### 2. Background of the Invention

A circuit breaker is a device for interrupting current flow in order to prevent an electricity accident when an abnormal current such as a short circuit and an over-current occurs.

Generally, the circuit breaker includes therein a fixed contact and a movable contact. While a normal current not the aforementioned abnormal current flows, the fixed contact and the movable contact come in contact with each other, thereby enabling current flow. On the other hand, while the aforementioned abnormal current flows, the fixed contact and the movable contact are separated from each other, thereby preventing current flow.

When the fixed contact and the movable contact are separated from each other, an arc is generated due to an abnormal current flowing on the fixed contact and the movable contact.

Such an arc includes high-temperature and high-pressure gas emitted by a plasma discharge, heat, a pressure, light ions, etc. Thus, a generated arc should be discharged to the outside of the circuit breaker within a short time, for prevention of damage of a structure of the circuit breaker.

Especially, the aforementioned fixed contact and movable contact can be easily damaged by a generated arc, because they are formed of a conductible material to be conductible when contacting each other.

The circuit breaker may be categorized into a small type and a medium-large type according to a rated capacity. The small circuit breaker is provided at home, and serves to interrupt a small amount of current.

Accordingly, the small circuit breaker is fabricated to have a small size so as to have only components required for circuit interruption. That is, it is difficult for the small circuit breaker to have an additional arc chamber for extinguishing a generated arc. The Korean Patent Laid-Open No. 10-2013-0048083 discloses an arc runner of a molded case circuit breaker having a structure to rapidly move arc roots to the arc runner. More specifically, disclosed is a molded case circuit breaker having a structure to rapidly move arc roots positioned at a fixed electrode to an arc runner, by increasing an electromagnetic force, by integrally forming a magnetic plate provided at the fixed electrode with the arc runner.

However, it is assumed that the arc runner and the molded case circuit breaker of such a structure are provided with an additional member for arc extinguishment. That is, the patent has a limitation in application to a small circuit breaker not having an arc chamber including a plurality of grids.

Korean Patent Registration Document No. 10-1827283 discloses a molded case circuit breaker having an additional arc guiding member. More specifically, disclosed is a molded case circuit breaker having a structure capable of rapidly transmitting an arc generated between a fixed contact and a movable contact to an arc chamber, by including an arc guiding member which transmits the arc to the arc chamber.

However, it is assumed that the molded case circuit breaker of such a structure is also provided with an additional arc chamber for arc extinguishment. Accordingly, there is a limitation that the patent cannot be applied to a small circuit breaker having no arc chamber, due to a size limitation or a size of a rated capacity.

### PRIOR ART DOCUMENTS

### Patent Documents

Korean Patent Laid-Open Document No. 10-2013-0048083 (May 9, 2013)

Korean Patent Registration Document No. 10-1827283 (Feb. 2, 2018)

### SUMMARY OF THE INVENTION

Therefore, an aspect of the detailed description is to provide a small circuit breaker having a structure capable of solving the aforementioned problems.

An aspect of the detailed description is to provide a small circuit breaker having a structure capable of effectively discharging a generated arc even without an arc chamber.

An aspect of the detailed description is to provide a small circuit breaker having a structure capable of extending a generated arc so as to have a sufficient length, and capable of obtaining a sufficient gap distance.

An aspect of the detailed description is to provide a small circuit breaker having a structure capable of effectively discharging a generated arc without considerably changing an internal structure of the small circuit breaker.

An aspect of the detailed description is to provide a small circuit breaker having a structure capable of effectively discharging a generated arc without an additional member.

To achieve these and other advantages and in accordance with the purpose of this specification, as embodied and broadly described herein, a small circuit breaker, comprising: a fixed contact carrier having a fixed contact; and a movable contact carrier having a movable contact formed to contact or to be separated from the fixed contact, wherein an arc guiding portion extended to a direction which becomes far from the fixed contact carrier so as to guide an arc generated when the movable contact is separated from the fixed contact, to a direction which becomes far from the fixed contact, is provided at the end of the movable contact carrier.

The arc guiding portion may include: a first extension portion extended horizontally from the movable contact carrier; and a second extension portion extended from the end of the first extension portion, with a predetermined angle with the movable contact carrier.

The predetermined angle may be within a range of 90°˜180°.

The movable contact carrier and the arc guiding portion may be integrally formed with each other.

The movable contact carrier and the arc guiding portion may be formed of an elastic material.

The movable contact carrier may be bent at a predetermined angle when the movable contact and the fixed contact come in contact with each other, and may become flat when the movable contact and the fixed contact are separated from each other.

The arc guiding portion may include: a first extension portion extended in parallel with the fixed contact carrier, in a contacted state between the fixed contact and the movable contact; and a second extension portion extended from the end of the first extension portion, with a predetermined angle with the first extension portion.

The predetermined angle may be within a range of 90°˜180°.

The movable contact carrier and the arc guiding portion may be formed of a material of a magnetic substance.

The small circuit breaker may further comprise a housing configured to accommodate therein the fixed contact carrier and the movable contact carrier. And an arc outlet may be formed at one side of the housing towards which the end of the arc guiding portion is.

The arc guiding portion may include: a first extension portion extended horizontally from the movable contact carrier; and a second extension portion extended from the end of the first extension portion, with a predetermined angle with the movable contact carrier.

The predetermined angle may be determined so that the arc outlet may be positioned on a virtual line extended from the second extension portion, in a contacted state between the fixed contact and the movable contact.

The predetermined angle may be determined so that the arc outlet may be positioned on a virtual line extended from the second extension portion, in a state that the fixed contact and the movable contact are separated from each other.

An arc generated as the fixed contact and the movable contact are separated from each other may be configured to be extended when the movable contact is moved, and to be guided by the arc guiding portion so as to be towards the arc outlet.

### Effects of the Present Invention

The present invention may have the following advantages.

Firstly, the arc guiding portion may be provided at the movable contact carrier to guide a path of a generated arc. Thus, the generated arc can be effectively discharged without an additional arc chamber.

Further, the arc guiding portion may be extended to an opposite direction to the fixed contact carrier. Thus, since an arc extension distance along the arc guiding portion is increased, a sufficient gap distance can be obtained.

Further, the arc guiding portion may be directly provided at the movable contact carrier, or may be integrally formed with the movable contact carrier. Thus, a generated arc can be effectively discharged without largely changing an inner structure of the small circuit breaker.

Further, the arc guiding portion may not be provided in the small circuit breaker as an additional member, but may be directly provided at the movable contact carrier or may be integrally formed with the movable contact carrier. Thus, a generated arc can be effectively discharged without an additional member.

### BRIEF DESCRIPTION OF THE DRAWINGS

FIG. 1 is a perspective view showing an internal structure of a small circuit breaker in accordance with the conventional art;

FIG. 2 is a sectional view showing the internal structure of the small circuit breaker of FIG. 1 in accordance with the conventional art;

FIG. 3 is a view showing an arc occurrence process from the small circuit breaker of FIG. 1 in accordance with the conventional art;

FIG. 4 is a partially cut-out perspective view showing an internal structure of a small circuit breaker according to an embodiment of the present invention;

FIG. 5 is a perspective view (a) and a side sectional view (b) showing a movable contact carrier and an arc guiding portion which are provided at the small circuit breaker of FIG. 4, respectively;

FIG. 6 is a sectional view showing an embodiment where an arc outlet is positioned on an extension line of a second extension portion of the arc guiding portion shown in FIG. 5, in a contacted state between a fixed contact and a movable contact;

FIG. 7 is a sectional view showing an embodiment where the arc outlet is positioned on the extension line of the second extension portion of the arc guiding portion shown in FIG. 5, in a separated state between the fixed contact and the movable contact;

FIG. 8 is a sectional view showing a moment when an arc is generated as the fixed contact and the movable contact are separated from each other in the small circuit breaker of FIG. 4; and

FIG. 9 is a sectional view showing a process to discharge an arc generated from the small circuit breaker of FIG. 4 to the outside through the arc guiding portion.

### DETAILED DESCRIPTION OF THE INVENTION

### 1. Explanations about the Conventional Art

An arc occurrence process from the conventional small circuit breaker will be explained as follows.

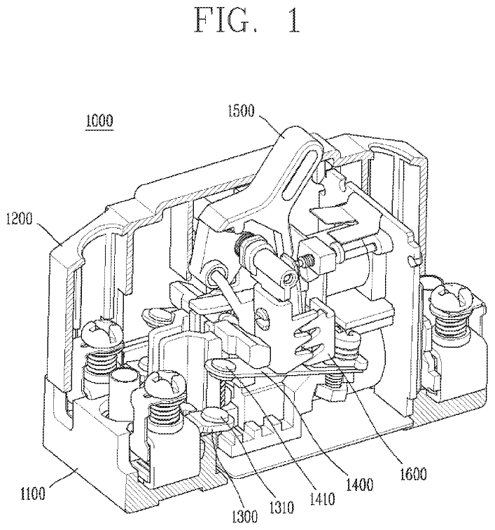

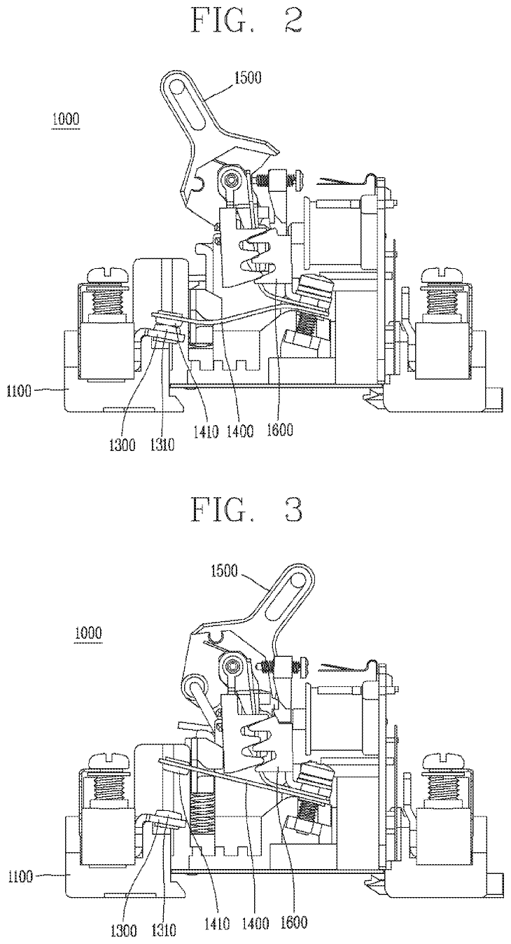

Referring to FIGS. 1 to 3, a small circuit breaker 1000 according to the conventional art includes a fixed contact carrier 1300 and a movable contact carrier 1400 supported by a base 1100 positioned therebelow. When an abnormal current such as a leakage current or an over-current occurs, a detection mechanism 1600 is operated to move a switching mechanism 1500. Such a process is referred to as a trip operation.

When the switching mechanism 1500 is tripped, a fixed contact 1310 of the fixed contact carrier 1300 and a movable contact 1410 of the movable contact carrier 1400 are separated from each other.

Here, the abnormal current which flows between the fixed contact 1310 and the movable contact 1410 is converted into an arc as the fixed contact 1310 and the movable contact 1410 are separated from each other. The generated arc is discharged through an arc outlet (not shown) formed at a cover 1200.

As aforementioned, it is difficult for a small circuit breaker to be provided with an arc chamber due to its size limitation. Thus, a generated arc is extended by depending on a movement of the movable contact carrier 1400.

That is, if an additional guide member is not provided, a generated arc may not be smoothly discharged to the arc outlet (not shown). Accordingly, if a time duration for which an arc remains between the fixed contact 1310 and the movable contact 1410 is long, the contacts 1310, 1410 may be damaged due to components of the arc.

Further, if the contacts 1310, 1410 have a deposition due to a severe damage thereof, the movable contact carrier 1400 may not be moved even if the switching mechanism 1500 is operated when a current occurs more than a predetermined number of times. As a result, a circuit interruption cannot be performed even if an abnormal current occurs, and an unfortunate accident may occur.

### 2. Definition of Terms

Hereinafter, the small circuit breaker according to an embodiment of the present invention will be explained in more detail with reference to the attached drawings.

In the following descriptions, explanations about some components may be omitted in order to clarify the technical features of the present invention.

The term of ‘circuit breaker’ explained in the following descriptions means any device capable of interrupting a current when a leakage current, an over-current, etc. are detected from an earth leakage circuit breaker, a molded case circuit breaker, etc.

The term of ‘small circuit breaker’ explained in the following descriptions means a circuit breaker having no arc chamber for extinguishing a generated arc, with a rated capacity less than a predetermined size. In an embodiment, the predetermined size may be 30 A (amp).

The term of ‘medium-large circuit breaker’ explained in the following descriptions means a circuit breaker having an additional arc chamber for extinguishing a generated arc, with a rated capacity more than a predetermined size. In an embodiment, the predetermined size may be 30 A (amp).

The term of ‘normal current’ explained in the following descriptions means a current which flows in a normal state where a circuit breaker does not perform an interruption operation.

The term of ‘abnormal current’ explained in the following descriptions means a current other than a normal current, where a circuit breaker performs an interruption operation. The abnormal current may include a leakage current, an over-current, an undercurrent, etc.

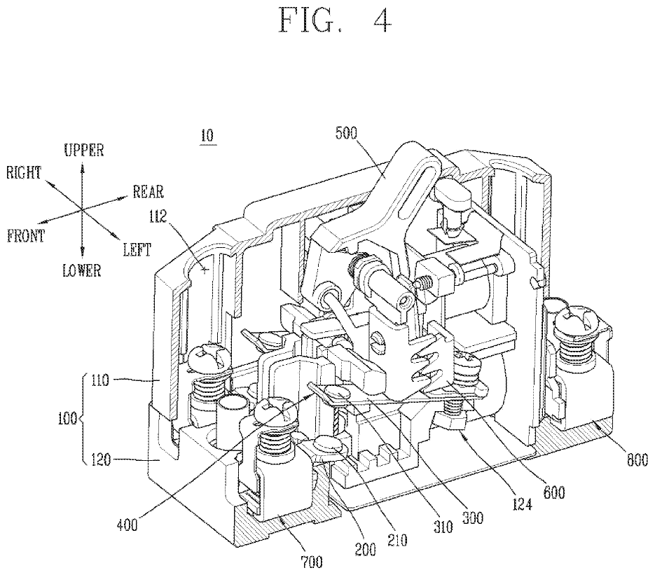

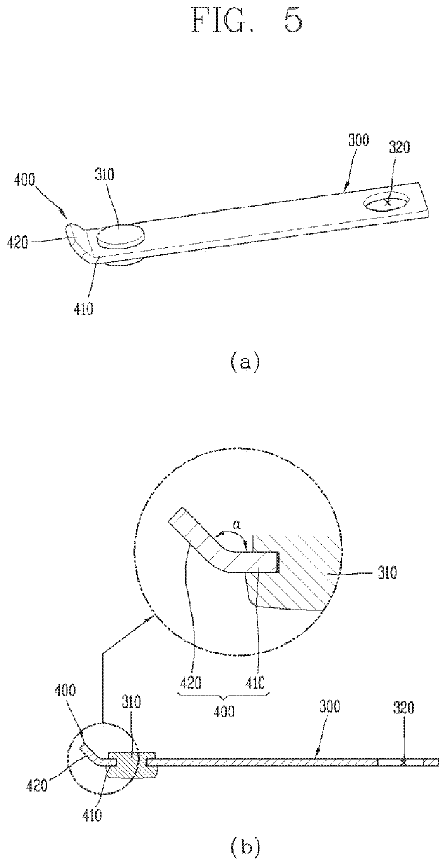

The term of ‘front side’, ‘rear side’, left side', ‘right side’, ‘upper side’ and ‘lower side’ explained in the following descriptions may be understood with reference to a coordinate system shown in FIG. 4

### 3. Explanations about a Configuration of the Small Circuit Breaker 10 According to an Embodiment of the Present Invention

Referring to FIG. 4, the small circuit breaker 10 according to an embodiment of the present invention includes a housing 100, a fixed contact carrier 200, a movable contact carrier 300, an arc guiding portion 400, a switching mechanism 500, a detection mechanism 600, an input terminal portion 700, and an output terminal portion 800.

Hereinafter, each configuration of the small circuit breaker 10 according to an embodiment of the present invention will be explained with reference to FIG. 4, but the arc guiding portion 400 will be explained separately.

(1) Explanations about the Housing 100

The housing 100 forms the appearance of the small circuit breaker 10. That is, the housing 100 serves as a case of the small circuit breaker 10.

The housing 100 is a part of the small circuit breaker 10 exposed to a user directly. Therefore, the housing 100 is preferably formed of an insulating material such as plastic.

In the illustrated embodiment, the housing 100 has a shape of a rectangular parallelepiped, but may have any shape to accommodate therein each component of the small circuit breaker 10 to be explained later.

The housing 100 includes an upper housing 110 and a lower housing 120.

The upper housing 110 forms an upper side of the housing 100. The housing 100 may be formed as the upper housing 110 is coupled to the lower to housing 120. For this, the upper housing 110 may be provided with a coupling means (not shown) for coupling with the lower housing 120.

An arc outlet 112 and a switching mechanism (not shown) are formed at the upper housing 110.

The arc outlet 112 is a passage for discharging an arc generated as a fixed contact 210 and a movable contact 310 to be explained later are spaced from each other. The arc outlet 112 is configured to communicate the inside of the upper housing 110, i.e., the inside of the small circuit breaker 10 with the outside. In an embodiment, the arc outlet 112 may be formed as a through hole.

In the illustrated embodiment, the arc outlet 112 is positioned at a front side of the upper housing 110, and the arc outlet 112 is formed on the right and left sides in two. The number of the arc outlets 112 may be variable according to the number of the fixed contact carrier 200 and the movable contact carrier 300 to be explained later.

In the illustrated embodiment, the arc outlet 112 is penetratingly-formed in upper and lower directions. However, the arc outlet 112 may be formed in any direction to effectively discharge a generated arc.

The arc outlet 112 is preferably formed in a direction towards which the end of the arc guiding portion 400 is. That is, the arc outlet 112 is preferably formed at a position where an extension line formed by extending the end of the arc guiding portion 400 reaches, or on the extension line .

A switching opening (not shown) is a passage for passing the switching mechanism 500 to be explained later. More specifically, a handle unit of the switching mechanism 500 to be explained later, which can be manipulated by a user, is coupled to the switching opening (not shown).

As explained later, the handle unit may be moved towards a front side and a rear side. Thus, a length of the switching mechanism (not shown) in back and forth directions is preferably formed to be longer than a moving distance of the switching mechanism 500.

In the illustrated embodiment, the switching mechanism (not shown) is positioned at an intermediate part of the upper housing 110 in back and forth directions. However, the position of the switching mechanism may be variable to correspond to a position of the handle unit of the switching mechanism 500 which is to be explained later.

The lower housing 120 forms a lower side of the housing 100. The lower housing 120 may be coupled to the upper housing 110. For this, a coupling means (not shown) for coupling to the upper housing 110 may be provided at the lower housing 120.

The lower housing 120 includes a fixed contact carrier fixing portion 122, and a movable contact carrier fixing portion 124.

The fixed contact carrier fixing portion 122 is a part to which the fixed contact carrier 200 to be explained later is coupled. The fixed contact carrier 200 should be fixed to the lower housing 120 even when an arc occurs. Thus, the fixed contact carrier fixing portion 122 is preferably formed such that the fixed contact carrier 200 may be fixedly-coupled thereto.

The movable contact carrier fixing portion 124 is a part to which the movable contact carrier 300 to be explained later is coupled. In the illustrated embodiment, the movable contact carrier fixing portion 124 includes a bolt inserted into a coupling hole 320 of the movable contact carrier 300, and a nut for fixing the bolt.

Thus, after the movable contact carrier 300 is coupled to the movable contact carrier fixing portion 124, the position of the movable contact carrier 300 in upper and lower directions may be variable. Accordingly, a contact load of the movable contact carrier 300 to the fixed contact carrier 200 may be controlled. This will be explained later in more detail.

(2) Explanations about the Fixed Contact Carrier 200

The fixed contact carrier 200 supports the fixed contact 210 so that the fixed contact 210 may maintain a preset position. In an embodiment, the fixed contact carrier 200 and the fixed contact 210 may be coupled to each other by a rivet, etc.

The fixed contact carrier 200 may be connected to the input terminal portion 700 to be explained later, for current flow. For smooth current flow, the fixed contact carrier 200 may be formed of a conductive material. Preferably, the fixed contact carrier 200 may be formed of a material of a magnetic substance.

The fixed contact 210 is provided at the fixed contact carrier 200.

The fixed contact 210 transmits a current applied through the input terminal portion 700 to be explained later, to the movable contact 310. Further, the fixed contact 210 is separated from the movable contact 310 when an abnormal current occurs, and an arc is generated.

More specifically, when a normal current flows, the fixed contact 210 and s the movable contact 310 come in contact with each other. As a result, a current may flow to the input terminal portion 700 and the output terminal portion 800 to be explained later.

When an abnormal current flows, the movable contact 310 contacting the fixed contact 210 is separated from the fixed contact 210, and an arc is generated. As a result, current flow between the input terminal portion 700 and the output terminal portion 800 to be explained later may be interrupted.

The fixed contact carrier 200 is coupled to the fixed contact carrier fixing portion 122 of the lower housing 120. Here, the fixed contact carrier 200 should not be moved even during a trip operation. Thus, the fixed contact carrier 200 is preferably fixedly-coupled to the fixed contact carrier fixing portion 122.

In the illustrated embodiment, the fixed contact carrier 200 includes a first part extended upward, and a second part extended downward to a rear direction. More specifically, the second part is downward extended to a rear direction, with a predetermined angle with the first part, an acute angle in the embodiment.

The fixed contact carrier 200 may have any shape to contact or separate the fixed contact 210 and the movable contact 310 to or from each other.

However, considering that the movable contact carrier 300 is formed of an elastic material and applies a contact load to the fixed contact carrier 200, as explained later, the second part of the fixed contact carrier 200 is preferably formed to be inclined.

(3) Explanations about the Movable Contact Carrier 300

The movable contact carrier 300 supports the movable contact 310 so that the movable contact 310 may maintain a preset position. In an embodiment, the movable contact carrier 300 and the movable contact 310 may be coupled to each other by a rivet, etc.

The movable contact carrier 300 may be connected to the output terminal portion 800 to be explained later, for current flow. For smooth current flow, the movable contact carrier 300 may be formed of a conductive material. Preferably, the movable contact carrier 300 may be formed of a material of a magnetic substance.

The movable contact carrier 300 may be formed of an elastic body. The reason is because the shape of the movable contact carrier 300 should be changed when a current applied to the small circuit breaker 10 is a normal current or an abnormal current. That is, the movable contact carrier 300 may be transformed or moved relatively with respect to the fixed contact carrier 200 having the same position and the same shape. This results in the name of the movable contact carrier 300.

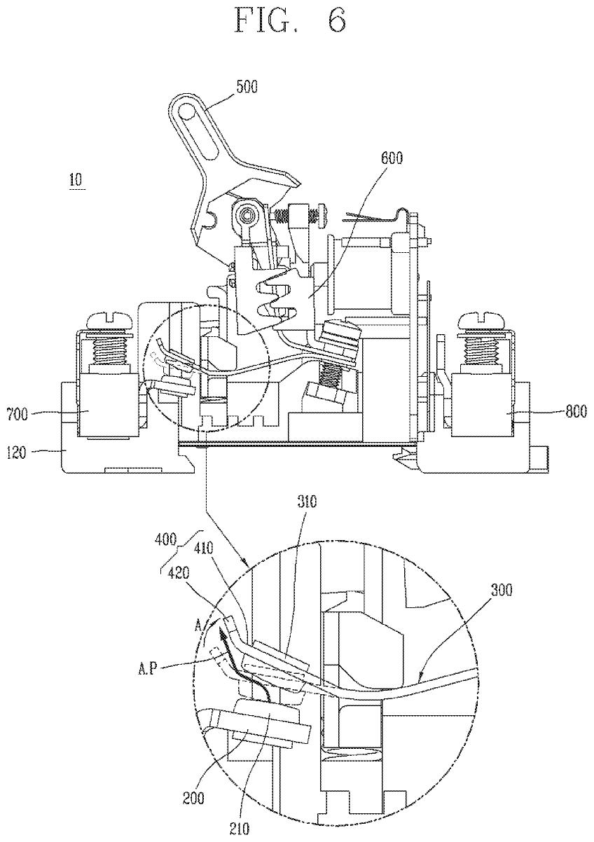

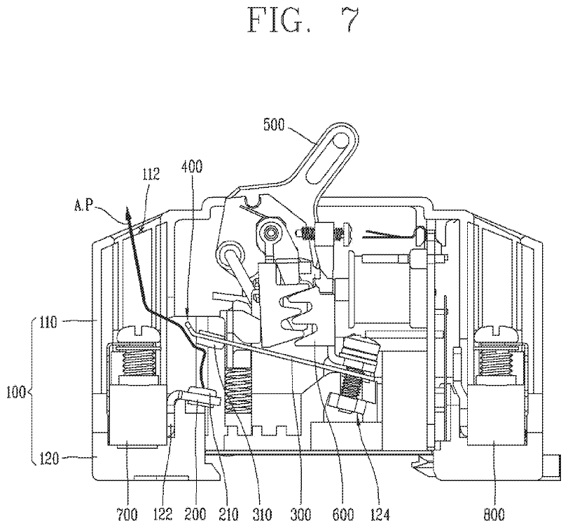

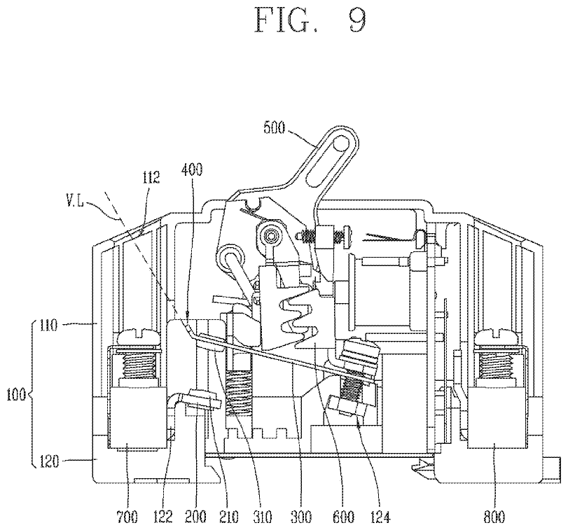

More specifically, the movable contact carrier 300 may be bent at a predetermined angle so that the movable contact 310 and the fixed contact 210 may contact each other when a normal current flows (Refer to FIGS. 6 and 8).

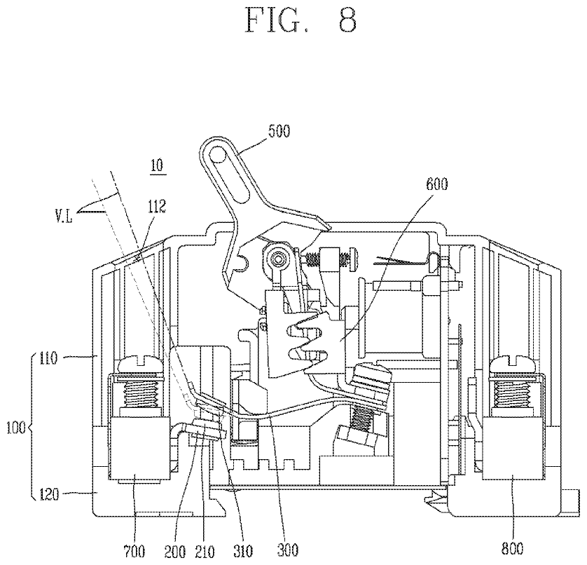

Further, the movable contact carrier 300 may be transformed to a flat shape so that the movable contact 310 and the fixed contact 210 may be separated from each other when an abnormal current flows (Refer to FIGS. 7 and 9).

Further, after a trip operation for interrupting an abnormal current, the movable contact carrier 300 may be bent again at a predetermined angle so that the movable contact 310 and the fixed contact 210 may contact each other.

The predetermined angle of the movable contact carrier 300 may be determined according to a position of the fixed contact carrier fixing portion 122 and the movable contact carrier fixing portion 124, and according to a position, a shape, etc. of the fixed contact carrier 200.

The movable contact carrier 300 is provided with the movable contact 310. And a coupling hole 320 is formed at another side opposite to the movable contact 310, in the embodiment, at the rear end (refer to FIG. 5).

The movable contact 310 transmits a current applied through the fixed contact 210 to the output terminal portion 800 to be explained later. Further, the movable contact 310 is separated from the fixed contact 210 when an abnormal current occurs, and an arc is generated.

More specifically, the fixed contact 210 and the movable contact 310 come is in contact with each other when a normal current occurs. Accordingly, a current may flow to the input terminal portion 700 and the output terminal portion 800 to be explained later.

As aforementioned, the movable contact carrier 300 may be transformed or moved relatively with respect to the fixed contact carrier 200. When an abnormal current occurs, the movable contact carrier 300 may be transformed or moved in a direction that the movable contact 310 contacting the fixed contact 210 is spaced away from the fixed contact 210.

Accordingly, as the movable contact 310 and the fixed contact 210 are separated from each other, an arc may be generated. As a result, current flow between the input terminal portion 700 and the output terminal portion 800 to be explained later may be interrupted.

The movable contact carrier 300 is coupled to the movable contact carrier fixing portion 124 of the lower housing 120. As aforementioned, the movable contact carrier 300 is formed of an elastic body, and its shape or position may be changed when an abnormal current occurs.

When the rear end of the movable contact carrier 300, i.e., the opposite end of the movable contact carrier to the movable contact 310 is moved, the movable contact carrier 300 may be moved to an unexpected direction.

Thus, it is preferable that the movable contact carrier 300 is fixedly-coupled to the movable contact carrier fixing portion 124. Alternatively, in an embodiment where the movable contact 310 and the fixed contact 210 are separated from each other as the position of the movable contact carrier 300 is changed, the movable contact carrier 300 may be coupled to the movable contact carrier fixing portion 124 so as to be moveable by a predetermined distance in is upper and lower direction.

As aforementioned, the coupling hole 320 is formed in upper and lower directions, at one side of the movable contact carrier 300, opposite to the movable contact 310, at the rear side in the embodiment.

A coupling means such as a bolt, provided at the movable contact carrier fixing portion 124, may be coupled to the coupling hole 320. Accordingly, the movable contact carrier 300 may be stably coupled to the movable contact carrier fixing portion 124.

In the embodiment shown in FIG. 4, the movable contact carrier 300 has a sectional surface of a rectangular shape, and has a rectangular plate shape long-extended in back and forth directions.

The movable contact carrier 300 has a rectangular plate shape which is flat when the movable contact 310 and the fixed contact 210 are separated from each other. In a contacted state between the movable contact 310 and the fixed contact 210, the movable contact carrier 300 is bent at a predetermined angle toward the fixed contact carrier 200.

As aforementioned, the movable contact carrier 300 is formed of an elastic material so that its shape may be changed when the movable contact 310 and the fixed contact 210 contact each other or are separated from each other.

The movable contact carrier 300 may have any shape suitable for the movable contact 310 to contact or to be separated from the fixed contact 210.

The arc guiding portion 400 to be explained later is provided at the front end of the movable contact carrier 300, i.e., the end adjacent to the movable contact 310. Detailed descriptions thereof will be explained later.

(4) Explanations about the Switching Mechanism 500

The switching mechanism 500 controls the movable contact carrier 300 so that the fixed contact 210 and the movable contact 310 may contact each other or may be separated from each other, as the movable contact carrier 300 is moved or has its shape transformed.

That is, the movable contact carrier 300 may be moved or may have its shape transformed, under control of the switching mechanism 500.

In an embodiment, the switching mechanism 500 may be maintained in one of ‘ON’, ‘TRIP’ and ‘OFF’ states.

More specifically, when the switching mechanism 500 is in an ‘ON’ state, the fixed contact 210 and the movable contact 310 may contact each other, and thus a current may flow to the input terminal portion 700 and the output terminal portion 800 to be explained later. This state may be referred to as an ‘input’ state.

When the switching mechanism 500 is in a ‘TRIP’ state, the fixed contact 210 and the movable contact 310 are separated from each other, and thus an arc is generated. A user may separate the fixed contact 210 and the movable contact 310 from each other by manually driving the switching mechanism 500.

When an abnormal current is detected from the small circuit breaker 10, the switching mechanism 500 may enter a ‘TRIP’ state mechanically or electronically by the detection mechanism 600 to be explained later.

As a result, a current flow between the input terminal portion 700 and the output terminal portion 800 to be explained later is interrupted.

When the switching mechanism 500 is in an ‘OFF’ state, the fixed contact 210 and the movable contact 310 are separated from each other, and thus a current flow between the input terminal portion 700 and the output terminal portion 800 to be explained later is interrupted. The ‘OFF’ state is different from the ‘TRIP’ state in that the switching mechanism 500 enters the ‘OFF’ state by a user's manipulation of the switching mechanism 500 when an abnormal current does not occur.

In the illustrated embodiment, the switching mechanism 500 includes a handle unit extended upward. Accordingly, a switching opening (not shown) for passing the handle unit of the switching mechanism 500 therethrough may be formed at the upper housing 110.

The switching mechanism 500 may be controlled mechanically or electrically by the detection mechanism 600 to be explained later, or may be directly controlled by a user with using the handle unit.

(5) Explanations about the Detection Mechanism 600

The detection mechanism 600 controls the switching mechanism 500 when an abnormal current is detected from the small circuit breaker 10. If the detection mechanism 600 controls the switching mechanism 500, the fixed contact 210 and the movable contact 310 may be separated from each other as the movable contact carrier 300 is moved or has its shape transformed.

In the embodiment, the detection mechanism 600 includes a first part disposed at a front side, and a second part disposed at a rear side. Each of the first and second parts includes a plurality of wedges. And a groove corresponding to the wedges is formed between the wedges.

In an embodiment, the first and second parts of the detection mechanism 600 may be operated as the wedge and the groove are engaged with each other.

As aforementioned, a user may select one of ‘ON’, ‘TRIP’, and ‘OFF’ states by manipulating the switching mechanism 500. In this case, the detection mechanism 600 may be manipulated by the switching mechanism 500.

Processes to move or transform the movable contact carrier 300 have been well-known, and thus detailed explanations thereof will be omitted.

(6) Explanations about the Input Terminal Portion 700

The input terminal portion 700 is a part of the small circuit breaker 10 where a current is input. That is, when the small circuit breaker 10 detects an abnormal current, the abnormal current to be interrupted is input to the input terminal portion 700.

Alternatively, a power required to operate the small circuit breaker 10 may be supplied to the input terminal portion 700.

In the illustrated embodiment, the input terminal portion 700 is provided at a front side of the small circuit breaker 10. And the input terminal portion 700 is provided in two on the right and left sides.

The input terminal portion 700 may be provided at any position where a current can be input from the outside. And the number of the input terminal portions 700 may be changed according to a rated capacity of the small circuit breaker 10.

In the illustrated embodiment, the input terminal portion 700 includes a conductive member for current flow, a fixing member for supporting the conductive member, and a coupling member for coupling the conductive member and the fixing member to each other.

The fixed contact carrier fixing portion 122 may be provided at the input terminal portion 700, thereby supporting the fixed contact carrier 200. Here, the input terminal portion 700 and the fixed contact carrier 200 are connected to each other for current flow, as aforementioned.

A current transmitted to the input terminal portion 700 is transmitted to the output terminal portion 800 to be explained later, via the fixed contact carrier 200 and the movable contact carrier 300, sequentially. Here, if the current is an abnormal current, the fixed contact 210 and the movable contact 310 are separated from each other to interrupt current flow, as aforementioned.

(7) Explanations about the Output Terminal Portion 800

The output terminal portion 800 is a part of the small circuit breaker 10 where a current is output. That is, the output terminal portion 800 outputs a current inputted through the input terminal portion 700, to the outside.

As aforementioned, a current inputted through the input terminal portion 700 is transmitted to the output terminal portion 800, via the fixed contact carrier 200 and the movable contact carrier 300, sequentially. That is, a normal current other than an abnormal current is transmitted to the output terminal portion 800.

In the illustrated embodiment, the output terminal portion 800 is provided at a rear side of the small circuit breaker 10. And the output terminal portion 800 is provided in two on the right and left sides.

The output terminal portion 800 may be provided at any position where a current can be output from the small circuit breaker. And the number of the output terminal portions 800 may be changed according to a rated capacity of the small circuit breaker 10.

In an embodiment, the number of the input terminal portions 700 may be the same as the number of the output terminal portions 800.

In the illustrated embodiment, the output terminal portion 800 includes a conductive member for current flow, a fixing member for supporting the conductive member, and a coupling member for coupling the conductive member and the fixing member to each other.

The output terminal portion 800 and the movable contact carrier 300 may be connected to each other for current flow, by an additional conducting member (not shown).

### 4. Explanations about the Arc Guiding Portion 400 According to an Embodiment of the Present Invention

Referring to FIG. 4, the small circuit breaker 10 according to the illustrated embodiment includes the arc guiding portion 400.

As aforementioned, the small circuit breaker 10 is a circuit breaker having a rated capacity less than a predetermined size (e.g., 30 A). The small circuit breaker 10 is not provided with an arc chamber for extinguishing a generated arc, due to its size limitation.

Accordingly, in a case that the fixed contact 210 and the movable contact 310 are separated from each other to generate an arc in order to interrupt an abnormal current, it is difficult to effectively discharge the generated arc to the outside of the small circuit breaker 10.

The small circuit breaker 10 according to an embodiment of the present invention includes the arc guiding portion 400 provided at the movable contact carrier 300. The arc guiding portion 400 is configured to effectively discharge an arc generated as the fixed contact 210 and the movable contact 310 are separated from each other, to the outside of the housing 100.

The arc guiding portion 400 to be explained in the following descriptions is preferably provided at the small circuit breaker 10. Alternatively, the arc guiding portion 400 according to an embodiment of the present invention may be provided at a medium-large circuit breaker so as to effectively discharge an arc.

However, a medium-large circuit breaker is generally provided with an arc chamber, additionally. Accordingly, if the arc guiding portion 400 is provided at the small circuit breaker 10, an arc discharge effect by the arc guiding portion 400 can be maximized.

Hereinafter, the arc guiding portion 400 according to an embodiment of the present invention will be explained in more detail with reference to FIGS. 5 to 7. The arc guiding portion 400 is provided at one end of the movable contact carrier 300. In the illustrated embodiment, the arc guiding portion 400 is provided at the front end of the movable contact carrier 300.

The arc guiding portion 400 is extended to a direction which becomes far from the fixed contact carrier 200. As aforementioned, the fixed contact carrier 200 according to an embodiment of the present invention includes a first part extended downward to a rear side (refer to FIG. 4 and FIGS. 6 to 9).

The arc guiding portion 400 is extended upward to a front side, from the front end of the movable contact carrier 300. Accordingly, the arc guiding portion 400 has a shape extended to a direction which becomes far from the fixed contact carrier 200.

The arc guiding portion 400 may be integrally formed with the movable contact carrier 300. That is, the arc guiding portion 400 may be formed as the front end of the movable contact carrier 300 is extended.

Alternatively, the arc guiding portion 400 may be formed as a separate member from the movable contact carrier 300, and then may be coupled to the movable contact carrier 300. In this case, for coupling to the movable contact carrier 300, an additional coupling member (not shown) may be provided or a bonding material (not shown) may be used.

The arc guiding portion 400 may be formed of the same material as the movable contact carrier 300. That is, the arc guiding portion 400 may be formed of an elastic material for transformation of some degree.

And the arc guiding portion 400 may be formed of a material of a magnetic substance in order to effectively guide an arc.

The arc guiding portion 400 includes a first extension portion 410 and a second extension portion 420.

The first extension portion 410 is a part where the arc guiding portion 400 contacts one end of the movable contact carrier 300. The first extension portion 410 is extended from the front end of the movable contact carrier 300.

In the illustrated embodiment, the first extension portion 410 is forward extended horizontally from the movable contact carrier 300. Alternatively, the first extension portion 410 may be extended in parallel with the fixed contact carrier 200, in a contacted state between the fixed contact 210 and the movable contact 310.

Alternatively, the first extension portion 410 may be extended with a predetermined angle with the movable contact carrier 300.

Here, the first extension portion 410 is preferably extended to the upper side in the illustrated embodiment, i.e., an opposite direction to the fixed contact carrier 200.

The second extension portion 420 is extended from the end of the first extension portion 410.

In the illustrated embodiment, the second extension portion 420 is formed with a predetermined angle (α) with the first extension portion 410 and the movable contact carrier 300 which is parallel to the first extension portion 410. Alternatively, the second extension portion 420 may be extended with a predetermined angle with a virtual line which is parallel to the fixed contact carrier 200, in a contacted state between the fixed contact 210 and the movable contact 310.

The predetermined angle (α) may be any angle that the second extension portion 420 can be extended to a direction which becomes far from the fixed contact carrier 200.

Alternatively, the predetermined angle (α) may be any angle that a virtual line extended from the second extension portion 420 can be towards the arc outlet 112.

In an embodiment, the predetermined angle (α) may be within a range of 90°˜180°. That is, the second extension portion 420 may be formed so as to be perpendicular to the first extension portion 410 and the movable contact carrier 300. And the angle between the second extension portion 420 and the first extension portion 410 and the movable contact carrier 300 may be an obtuse angle.

If the angle between the second extension portion 420 and the first extension portion 410 and the movable contact carrier 300 is an acute angle, an arc which tends to be towards the peak may not be extended towards the arc outlet 112.

Further, if the angle between the second extension portion 420 and the first extension portion 410 and the movable contact carrier 300 is 180°, the second extension portion 420, the first extension portion 410 and the movable contact carrier 300 form a planar surface. In this case, the arc guiding portion 400 for inducing an arc to an opposite direction to a direction which is towards the fixed contact carrier 200 may have a lowered effect.

Therefore, the predetermined angle (α) between the first extension portion 410 and the second extension portion 420 is preferably formed within a range of 90°˜180°.

Referring to FIG. 6, illustrated is the shape of the arc guiding portion 400 according to an embodiment of the present invention. In the illustrated embodiment, a virtual line (VL) formed by extending the second extension portion 420 when the fixed contact 210 and the movable contact 310 contact each other or are separated from each other, may be configured to pass through the arc outlet 112.

More specifically, referring to the dotted line shown in FIG. 6, the second extension portion 420 may be formed so that the arc outlet 112 may be positioned on the virtual line (VL) extended from the end of the second extension portion 420, in a contacted state between the fixed contact 210 and the movable contact 310.

That is, the predetermined angle (α) between the first extension portion 410 and the second extension portion 420 may be determined so that the virtual line (VL) extended from the end of the second extension portion 420 may pass through the arc outlet 112.

Referring to the alternate long and short dash line of FIG. 6, the second extension portion 420 may be formed so that the arc outlet 112 may be positioned on the virtual line (VL) extended from the end of the second extension portion 420, when the fixed contact 210 and the movable contact 310 are separated from each other.

That is, in this embodiment, the predetermined angle (α) between the first extension portion 410 and the second extension portion 420 may be determined so that the virtual line (VL) extended from the end of the second extension portion 420 may pass through the arc outlet 112.

Referring to FIG. 7, illustrated is the shape of the arc guiding portion 400 according to another embodiment of the present invention. In the illustrated embodiment, a virtual line (VL) formed by extending the second extension portion 420 in a state that the fixed contact 210 and the movable contact 310 are separated from each other, may be configured to pass through the arc outlet 112.

More specifically, referring to the dotted line shown in FIG. 7, the second extension portion 420 may be formed so that the arc outlet 112 may be positioned on the virtual line (VL) extended from the end of the second extension portion 420, in a state that the fixed contact 210 and the movable contact 310 are separated from each other due to an arc occurrence.

That is, the predetermined angle (α) between the first extension portion 410 and the second extension portion 420 may be determined so that the virtual line (VL) extended from the end of the second extension portion 420 may pass through the arc outlet 112.

In the embodiment shown in FIG. 6, the second extension portion 420 is formed to be towards the arc outlet 112 when the fixed contact 210 and the movable contact 310 contact each other or are separated from each other.

Thus, an arc may be guided so as to be towards the arc outlet 112, from a moment when an arc is generated as the fixed contact 210 and the movable contact 310 are separated from each other.

In the embodiment shown in FIG. 7, the second extension portion 420 is formed to be towards the arc outlet 112 when the fixed contact 210 and the movable contact 310 are separated from each other, and when the switching mechanism 500 is controlled to a ‘TRIP’ state.

Since a generated arc is guided towards the arc outlet 112, the arc can be rapidly discharged from the small circuit breaker 10.

The arc guiding portion 400 according to the embodiment shown in FIG. 6 and the arc guiding portion 400 according to the embodiment shown in FIG. 7 may be provided independently. That is, the small circuit breaker 10 may be provided with one of the arc guiding portions 400 according to the embodiments shown in FIGS. 6 and 7.

As aforementioned, the arc guiding portion 400 may be formed of an elastic material for shape transformation of some degree.

In embodiments not illustrated, the arc guiding portion 400 may be configured to have its shape transformed according to the embodiments shown in FIGS. 6 and 7. That is, the arc guiding portion 400 of the small circuit breaker 10 may be provided so that its shape may be transformed to the shape according to the embodiments shown in FIGS. 6 and 7.

An extension length of each of the first extension portion 410 and the second extension portion 420 may be determined by considering an inner space of the small circuit breaker 10.

More specifically, it is advantageous that the extension length of each of the first extension portion 410 and the second extension portion 420 is long in order for the arc guiding portion 400 to effectively induce an arc. However, considering that an inner space of the small circuit breaker 10 is narrow, the extension length of each of the first extension portion 410 and the second extension portion 420 should be limited to some degree.

Referring to FIG. 4 again, the aforementioned input terminal portion 700 is positioned at a front side of the second extension portion 420. Preferably, a maximum extension length of each of the first extension portion 410 and the second extension portion 420 is determined not to contact the input terminal portion 700.

If the movable contact carrier 300 contacts the input terminal portion 700, current flow is still performed, even if the fixed contact 210 and the movable contact 310 are separated from each other as an abnormal current is detected. As a result, the occurrence of an electric accident cannot be prevented.

In the illustrated embodiment, a front end surface of the second extension portion 420, which is opposite to the movable contact 310, is chamfered, thereby having five surfaces. Alternatively, the front end surface of the second extension portion 420 may not be chamfered, thereby having a rectangular sectional surface.

As aforementioned, an arc tends to be towards the peak. Accordingly, in order to maximize an arc inducing effect of the arc guiding portion 400, the second extension portion 420 is preferably formed to have a shape that its surface area is decreased towards the end.

In embodiments not illustrated, the second extension portion 420 may have a triangular shape having a part contacting the first extension portion 410 as a base line, and having a vertex at a direction which is towards the end.

In another embodiment, only the second extension portion 420 may be provided without the first extension portion 410. That is, the second extension portion 420 is directly extended from the movable contact carrier 300.

In said embodiment, the second extension portion 420 may be extended with a predetermined angle (α) with the movable contact carrier 300. Here, the predetermined angle (α) is preferably within a range of 90°˜180°, as aforementioned in the illustrated embodiment.

In the illustrated embodiment, the second extension portion 420 has a polygonal shape having a planar surface. Alternatively, the second extension portion 420 may have a curved object shape curved towards the front side. In this case, the second extension portion 420 is extended to an opposite direction to a direction which is towards the fixed contact carrier 200, as aforementioned.

### 5. Explanations about a Process to Discharge an Arc from the Small Circuit Breaker 10 According to an Embodiment of the Present Invention

The arc guiding portion 400 is provided at the front end of the movable contact carrier 300 of the small circuit breaker 10 according to an embodiment of the present invention. If an arc is generated as the fixed contact 210 and the movable contact 310 are separated from each other due to a detected abnormal current, the arc guiding portion 400 may induce a generated arc so that the generated arc may be discharged through the arc outlet 112 of the housing 100.

Hereinafter, a process to discharge an arc from the small circuit breaker 10 according to an embodiment of the present invention will be explained in more detail with reference to FIGS. 8 and 9.

Referring to FIG. 8, illustrated is a moment when the fixed contact 210 and the movable contact 310 are separated from each other.

Here, the switching mechanism 500 is in an ‘ON’ state, i.e., a state where a normal current flows (refer to the switching mechanism 500 in contrast to the switching mechanism 500 shown in FIGS. 4, 7 and 9).

That is, the state shown in FIG. 8 is a state that an arc was generated as the fixed contact 210 and the movable contact 310 were separated from each other due to an abnormal current, but a state before the detection mechanism 600 controls the switching mechanism 500 into a ‘TRIP’ state.

As aforementioned, while the fixed contact 210 and the movable contact 310 contact each other, the movable contact carrier 300 is bent at a predetermined angle.

The movable contact carrier 300 is formed of an elastic material. Thus, the movable contact 310 applies a load (contact load) to press the fixed contact 210 downward, to the fixed contact 210 (refer to the dotted line).

If an abnormal current is transmitted to the fixed contact 210 and the movable contact 310 through the input terminal portion 700, an electrodynamic repulsive force exceeding the contact load is generated between the fixed contact 210 and the movable contact 310.

Accordingly, the movable contact carrier 300 is moved or has its shape transformed, and the fixed contact 210 and the movable contact 310 are separated from each other.

Here, as the abnormal current is interrupted at a space between the fixed contact 210 to which a current is input and the movable contact 310, a path of a generated arc (A.P) is formed.

As aforementioned, an arc tends to be towards the peak. And the second extension portion 420 is extended to a direction which becomes far from the fixed contact carrier 200. That is, the upper end of the second extension portion 420 may serve as the peak.

Accordingly, the arc path (A.P) is extended from the fixed contact 210 to the upper end of the arc guiding portion 400, i.e., the upper end of the second extension portion 420, via the movable contact 310.

Thus, since a generated arc remains at the fixed contact 210 or the movable contact 310 for an excessive time, the fixed contact 210 or the movable contact 310 is not damaged.

Referring to FIG. 9, illustrated is a state that the detection mechanism 600 detected an abnormal current, and controlled the switching mechanism 500 to be open (refer to the switching mechanism 500 in contrast to the switching mechanism 500 shown in FIGS. 6 and 8).

That is, the state shown in FIG. 9 is a state that an arc was generated as the fixed contact 210 and the movable contact 310 were separated from each other due to an abnormal current, and then the detection mechanism 600 controlled the switching mechanism 500 into a ‘TRIP’ state.

As the fixed contact 210 and the movable contact 310 are completely separated from each other, the movable contact carrier 300 is restored to a rectangular flat plate shape. In this process, the fixed contact 210 and the movable contact 310 are more spaced apart from each other.

The arc path (A.P) is extended from the fixed contact 210 along the movable contact 310. Since an arc tends to be towards the peak, the arc path (A.P) is extended towards the end of the second extension portion 420 of the arc guiding portion 400 which forms the peak of the movable contact carrier 300.

As aforementioned, the predetermined angle (α) between the second extension portion 420 and the first extension portion 410 and the movable contact carrier 300 may be determined within a range of 90°˜180°.

Further, the predetermined angle (α) may be determined so that a virtual line extending the second extension portion 420 may be towards the arc outlet 112. Thus, the arc path (A.P) is extended to a direction which becomes far from the is fixed contact 210. At the same time, the arc path (A.P) is extended towards the arc outlet 112.

More specifically, when an arc is generated as the fixed contact 210 and the movable contact 310 are separated from each other, an arc pressure of a high pressure is also generated. The generated arc pressure is guided by the arc guiding portion 400, thereby being extended towards the arc outlet 112.

That is, the arc path (A.P) is extended towards the arc outlet 112 from the fixed contact 210 via the movable contact 310 and the arc guiding portion 400, due to a tendency that a generated arc is towards the peak, and due to an arc pressure.

Thus, the arc path (A.P) may be extended much enough to obtain a sufficient gap distance. Accordingly, a generated arc can be rapidly extinguished, and damage of the fixed contact 210 and the movable contact 310 due to the generated arc can be prevented.

### 6. Explanations about Effects of the Small Circuit Breaker 10 According to an Embodiment of the Present Invention

In the small circuit breaker 10 according to an embodiment of the present invention, the arc guiding portion 400 extended to a direction which becomes far from the fixed contact carrier 200 is provided at the movable contact carrier 300.

Thus, an arc path of an arc generated as the fixed contact 210 and the movable contact 310 are separated from each other due to an abnormal current, may be guided to the arc outlet 112 through the arc guiding portion 400.

Under the structure, the small circuit breaker 10 having no additional arc chamber can discharge an arc effectively.

The arc guiding portion 400 is extended to a direction which becomes far from the fixed contact carrier 200. An arc pressure generated together with an arc is moved towards the arc outlet 112, along the arc guiding portion 400. And an arc tends to be towards the peak.

Thus, an arc path (A.P) of a generated arc is extended towards the end of the arc guiding portion 400, i.e., to a direction which becomes far from the fixed contact carrier 200. And the arc path (A.P) is moved together with an arc pressure which is towards the arc outlet 112.

Accordingly, the arc path (A.P) can be extended much enough to obtain a sufficient gap distance. As a result, an arc can be rapidly extinguished, and thus damage of the fixed contact 210 and the movable contact 310 can be prevented.

The arc guiding portion 400 may be directly provided at one end of the movable contact carrier 300, or may be integrally formed with the movable contact carrier 300. Thus, an additional structure change except for the shape of the movable contact carrier 300 is not required, and an additional member for arc extinguishment is not necessary.

Accordingly, a generated arc can be effectively discharged without considerably changing the structure of the small circuit breaker 10, or without performing a design change for providing an additional member, etc.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

1. A small circuit breaker, comprising:
a fixed contact carrier having a fixed contact;
a movable contact carrier having a movable contact formed to contact or to be separated from the fixed contact; and
a housing configured to accommodate therein the fixed contact carrier and the movable contact carrier,
wherein an arc outlet is formed at one side of the housing,
wherein an arc guiding portion extended to a direction opposite to the fixed contact carrier and towards the arc outlet so as to guide an arc generated when the movable contact is separated from the fixed contact, to a direction opposite to the fixed contact, is provided at an end of the movable contact carrier, and
wherein no arc chamber is provided on a virtual line extended from an end of the arc guiding portion to the arc outlet.

2. The small circuit breaker of claim 1, wherein the arc guiding portion includes:
a first extension portion extended horizontally from the movable contact carrier; and
a second extension portion extended from an end of the first extension portion, with a predetermined angle with the movable contact carrier.

3. The small circuit breaker of claim 2, wherein the predetermined angle is within a range of 90°˜180°.

4. The small circuit breaker of claim 1, wherein the movable contact carrier and the arc guiding portion are integrally formed with each other.

5. The small circuit breaker of claim 1, wherein the movable contact carrier and the arc guiding portion are formed of an elastic material.

6. The small circuit breaker of claim 5, wherein the movable contact carrier is bent at a predetermined angle when the movable contact and the fixed contact come in contact with each other, and
wherein the movable contact carrier becomes flat when the movable contact and the fixed contact are separated from each other.

7. The small circuit breaker of claim 1, wherein the arc guiding portion includes:
a first extension portion extended in parallel with the fixed contact carrier, in a contacted state between the fixed contact and the movable contact; and
a second extension portion extended from an end of the first extension portion, with a predetermined angle with the first extension portion.

8. The small circuit breaker of claim 7, wherein the predetermined angle is within a range of 90°˜180°.

9. The small circuit breaker of claim 1, wherein the movable contact carrier and the arc guiding portion are formed of a material of a magnetic substance.

10. (canceled)

11. The small circuit breaker of claim 1, wherein the arc guiding portion includes:
a first extension portion extended horizontally from the movable contact carrier; and
a second extension portion extended from an end of the first extension portion, with a predetermined angle with the movable contact carrier.

12. The small circuit breaker of claim 11, wherein the predetermined angle is determined so that the arc outlet is positioned on a virtual line extended from the second extension portion, in a contacted state between the fixed contact and the movable contact.

13. The small circuit breaker of claim 11, wherein the predetermined angle is determined so that the arc outlet is positioned on a virtual line extended from the second extension portion, in a state that the fixed contact and the movable contact are separated from each other.

14. The small circuit breaker of claim 1, wherein the arc generated as the fixed contact and the movable contact are separated from each other is configured to be extended when the movable contact is moved, and to be guided by the arc guiding portion so as to be towards the arc outlet.
